(19) United States
(12) Patent Application Publication
(10) Pub. No.: US 2012/0066311 A1
(43) Pub. Date: Mar. 15, 2012

(54) NETWORK CONNECTION ESTABLISHMENT AND DATA TRANSMISSION METHOD

(75) Inventors: Wei-Cheng Wang, Santa Ana, CA (US); Ping-Shun Zeung, Santa Ana, CA (US); Yung-Shen Chang, Santa Ana, CA (US); Chen-Ming Lee, Santa Ana, CA (US); Hong-Yi Huang, Santa Ana, CA (US)

(73) Assignee: I O INTERCONNECT, LTD., Santa Ana, CA (US)

(21) Appl. No.: 12/978,357

(22) Filed: Dec. 23, 2010

Related U.S. Application Data
(60) Provisional application No. 61/381,134, filed on Sep. 9, 2010.

(51) Int. Cl. G06F 15/16

(52) U.S. Cl. 709/205

(57) ABSTRACT

The present innovation discloses a network communication establishment method between a portable device and a computer. The major feature of the present innovation is that the parameters are transmitted via the email and after the connection is established, the commands or requests for data transmission are still transmitted via email. As to the data under transmission, it is transmitted by peer to peer (P2P) technology. In another embodiment, the data may also be transmitted via email.

### CROSS REFERENCE TO RELATED APPLICATIONS

This application claims the benefit of U.S. Provisional Application No. 61/381,134, filed Sep. 9, 2010, the entirety of which is incorporated by reference herein.

### BACKGROUND OF THE INVENTION

1. Field of the Invention

The present invention relates to network communication and more particularly to a network connection establishment method via email.

2. Description of the Related Art

A firewall is a part of a computer system or network that is designed to block unauthorized access while permitting authorized communications. It is a device or set of devices that is configured to permit or deny network transmissions based upon a set of rules and other criteria. Firewalls can be implemented in either hardware or software, or a combination of both. Firewalls are frequently used to prevent unauthorized Internet users from accessing private networks connected to the Internet, especially intranets.

### BRIEF SUMMARY OF THE INVENTION

The invention provides a network connection establishment method for a first electronic device and a second electronic device, comprising: transmitting a first network information of the first electronic device to the second electronic device via a first message; transmitting a second network information of the second electronic device to the first electronic device via a second message; establishing a network connection between the first electronic device and the second electronic device according to the first network information and the second network information.

A system in a network environment is provided. The system comprises a first electronic device, a second electronic device and a third party. The first electronic device establishes a network connection to the second electronic device via the third party and after the network connection is established, the first electronic device directly transmits data to the second electronic device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of data transmission system according to one embodiment of the invention.

FIG. 2 is a network connection establishment sequence according to one embodiment of the invention.

FIG. 3 is a flowchart of a data transmission method between two electronic devices according to one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present innovation discloses a network communication establishment method between a portable device and a computer. The following paragraphs are illustrated with a smart phone and a personal computer (or another portable device), but does not limit the invention thereto. The communication method exchanges some parameters between the portable device and the computer to establish a network connection for data transmission. The major feature of the present innovation is that the parameters are transmitted via email and after the connection is established, the commands or requests for data transmission are transmitted via email. As to the data under transmission, they are transmitted by peer to peer (P2P) technology. In another embodiment, the data may also be transmitted via email.

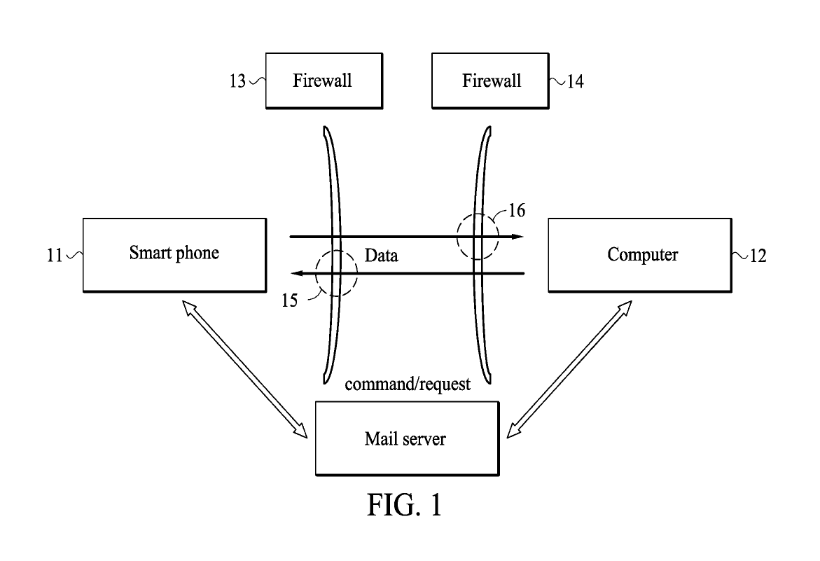

FIG. 1 is a schematic diagram of data transmission system according to one embodiment of the invention. The computer 12 first acquires network information containing the IP address, port information and NAT (network address translator) type information of the computer 12 from a STUN (session traversal utilities for NAT) server. The computer 12 talks to the STUN server every period of time (usually 3 to 30 seconds by the distance of the devices to the server) and sends an email to the user's email account if the IP or Port of the computer 12 changes. In other embodiments, the computer 12 can adjust the time period by a user's requirement, or only when the IP or Port changes, wherein an interrupt signal informs the processor of the computer 12 to acquire the updated network information. The smart phone 11 also acquires its network information comprising IP address, port information, router information and NAT (network address translator) type information from a STUN (session traversal utilities for NAT) server.

When the computer 12 gets its IP address, port information and NAT type information, the computer 12 sends an email comprising the described information to a first email account via the mail server. The embodiment illustrates with the email, however, not to limit the invention thereto. The computer 12 can send a first message, such as a short message, containing the described information to a third party and the third party transfers the message to the smart phone 11. In another example, the first message can be embedded in the first email and sent to the first email account via the mail server. In order to get the IP and Port information of the computer 12, the smart phone will check the email first when an application program (AP) embedded in the smart phone 11 is activated. After the smart phone 11 receives the network information of the computer 12, the smart phone 11 sends the IP, Port and router's NAT type of the smart phone 11 to a second email account. Similarly, the smart phone 11 can send a second message, such as a short message, containing the described information to a third party and the third party transfers the message to the computer 12. In another example, the second message can be embedded in the second email and sent to the second email account via the mail server. It is noted that the first email account may be the same as the second email account. If the first email account is the same as the second email account, the computer 12 and smart phone 11 determine which email is designated to the computer 12 or smart phone 11 according to the email title or the email content.

The computer 12 will check the second email account at every period of time, such as 30 seconds or so, to determine whether the smart phone 11 is turned on and is trying to connect to the computer 12. When the smart phone 11 receives the network information of the computer 12, the smart phone 11 then pings the computer 12 according to the network information of the computer 12. The computer 12 then responds to the pings of the smart phone 11 according to the network information of the smart phone 11. If the described steps have been completed, the connection between the smart phone and PC is then established. The data is then transmitted via the available port and the command/request is transmitted via email.

When establishing the network connection, the computer 12 informs the smart phone 11 which port of the firewall 14 is available for data transmission, such as port 16, and the smart phone 11 also informs the computer 12 which port of the firewall 13 is available for data transmission, such as port 15. After the network connection is established, the computer receives data from the smart phone 11 via the port 16 and the smart phone 11 receives data from the computer 12 via the port 15. The following paragraph describes, in more detail, the data transmission mechanism.

Data Transmitted from the Smart Phone 11 to the Computer 12

A second application program of the smart phone 11 transmits a request to the computer 12 via email and the computer 12 responds to the smart phone 11 with an ACK message via email to inform the computer 12 that the second application program has started to transmit data to the computer 12 and the port 16 must be opened. When the network connection is already established, the control of the port 16 is then transferred to the computer 12. The data is then directly transmitted to the computer 12 via the port 16. When the data is completely transmitted, the second application program transmits a message to the computer 12 via email and the computer 12 closes the port 16.

Data Transmitted from Computer 12 to the Smart Phone 11

The first application program of the computer 12 transmits a request to the smart phone via email and the smart phone 11 responds to the computer 12 with an ACK message via email to inform the computer 12 that the first application program has started to transmit data to the smart phone 11 and the port 15 is opened. When the network connection is established, the control of port 15 is transferred to the smart phone 11. The data is then directly transmitted to the smart phone 11 via the port 15. When the data is completely transmitted, the first application program transmits a message to the smart phone 11 via email and the smart phone 11 closes the port 15.

Smart Phone Access PC

When the smart phone 11 wants to acquire some data, folder or files from the computer 12, the smart phone 11 first transmits a command to the computer 12 via email and informs the computer 12 that the port 15 is available for transmission. The computer 12 responds to the smart phone 11 with an ACK message via email to inform the smart phone 11 that that the data is ready to be accessed. The smart phone 11 opens the port 15 and informs the computer 12 to start transmitting data. After data is completely transmitted, the computer 12 sends a message to the smart phone 11 via email and smart phone 11 then stops receiving data and closes the port 15.

The Computer 12 Access Smart Phone

When the computer 12 wants to acquire some data, folder or files from the smart phone 11, the computer 12 first transmits a command to the smart phone 11 via email and informs the smart phone 11 that port 16 is available for transmission. The smart phone 11 then responds to the computer 12 with an ACK message via email to inform the smartphone that that the data is ready to be accessed. The computer 12 opens the port 16 and informs the smart phone 11 to start transmitting data. After the data is completely transmitted, the smart phone 11 sends a message to the computer 12 via email and the computer 12 then stops receiving data and closes the port 16.

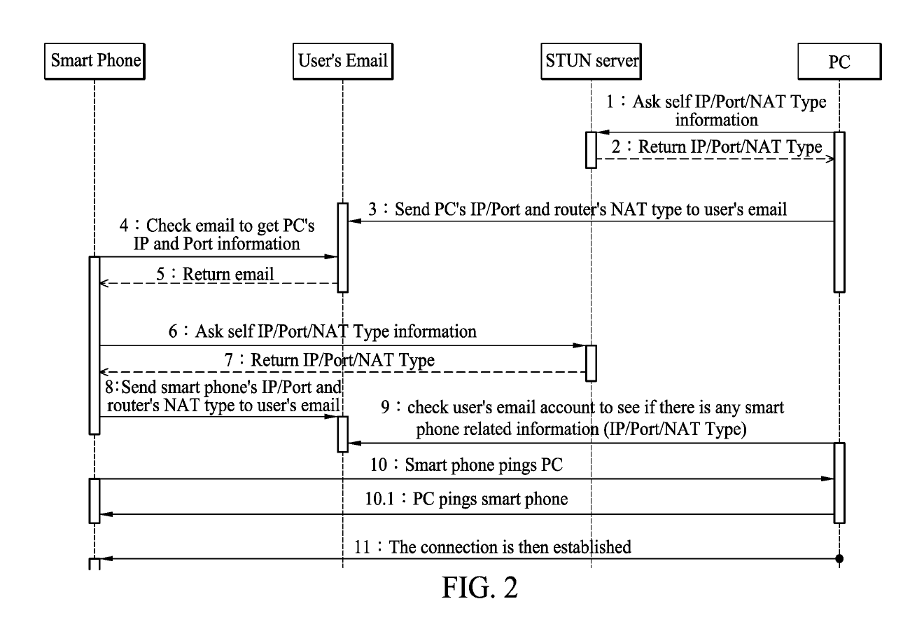

FIG. 2 is a network connection establishment sequence according to one embodiment of the invention. The following paragraph describes the network connection establishment sequence step by step.

Step 1: A PC first transmits a request to the STUN server to acquire the PC's network information (first network information) comprising the PC's IP, available port (hole), NAT type information, and other necessary information. The available port means that the PC can receive data from the smart phone through the firewall and the port can be controlled by a first application program (AP) of the PC. The first AP can open the port to receive data or closes the port to stop receiving data from the smart phone.

The PC talks to the STUN server every certain period of time (30 seconds here) and sends an email to the user's account if the PC's IP or Port changes. In other embodiments, the PC can adjust the time period by a user's requirement, or when the PC's IP or Port changes, wherein an interrupt signal informs the first AP to acquire the updated network information.

Step 2: The STUN server returns the first network information to the PC and transfers the control of a first port to the first AP.

Step 3: After receiving the first network information, PC sends the first network information to a first email account.

Step 4: When a second application program (AP) is started, the second AP first checks the first email account to get the first network information.

Step 5: If the first email account receives the email containing the first network information, the email is returned to the smart phone.

After receiving the first network information, the second AP embedded in the smart phone still periodically checks the first email account to see whether the PC's network information has changed.

Step 6: The Smart Phone transmits a request to the STUN server to acquire the Smart Phone's network information (second network information) comprising the Smart Phone's IP, available port (hole), NAT type information, and other necessary information. The available port means that the Smart Phone can receive data from the PC through the firewall and the port can be controlled by a second application program (AP) of the smart Phone. The second AP can open the port to receive data or close the port to stop receiving data from PC.

Step 7: The STUN server returns the second network information to the PC and transfers the control of a second port to the second AP.

Step 8: After receiving the second network information, the Smart Phone sends the second network information to a second email account. The first email account and the second email account may be from the same. PC and smart phone can know which email is designated to the PC or the smart phone according to the e-mail's title, content, sender or other information.

Step 9: The PC or the first AP will check the first email account to see if there is any smart phone related information, such as the second network information. The PC checks the first email account periodically to see if the second AP of the smart phone is on and is trying to connect to the PC.

Step 10: The smart phone pings the PC according to the first network information. Take FIG. 1 for example, the smart phone pings to the PC via the port 16. If the smart phone successfully pings the PC, the smart phone will send a message to the PC.

Step 10.1: The PC pings back to the smart phone according to the second network information to respond to the pings from the smartphone. Take FIG. 1 for example, the PC pings the smart phone via the port 15. If the PC successfully pings the smart phone, the PC will send a message to the smart phone.

Step 11: When the described steps are successfully completed, a network connection between the PC and the smart phone is then established. The data will be transmitted via the network connection, however, the command or request is still transmitted via email.

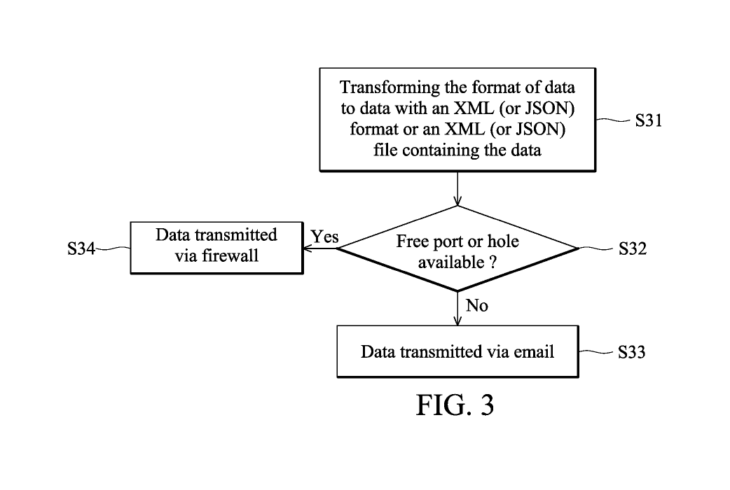

FIG. 3 is a flowchart of a data transmission method between two electronic devices according to one embodiment of the present disclosure. In step S31, the data is transformed to data with an XML (or JSON) format or an XML (or JSON) file containing the data which has to be transmitted is created by an electronic device, such as a mobile phone or computer.

In step S32, both the electronic devices get their respective IP and port from the rendezvous server to determine whether a free port or hole is available for data transmission. If yes, the procedure goes to step S34, and the data will be transmitted via firewalls. If not, the procedure goes to step S33, and the data will be transmitted via e-mail. In another embodiment, the step S32 may be executed prior to the step S31, wherein the data format transformation is executed before transmission.

Although the present innovation is described above, other data transmission technologies may also be applied, such encoding, encrypting, security mechanism and other technologies.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A network connection establishment method for a first electronic device and a second electronic device, comprising:
transmitting a first network information of the first electronic device to the second electronic device via a first message;
transmitting a second network information of the second electronic device to the first electronic device via a second message; and
establishing a network connection between the first electronic device and the second electronic device according to the first network information and the second network information.

2. The method as claimed in claim 1, wherein the first message is embedded in a first email and the second message is embedded in a second email.

3. The method as claimed in claim 1, wherein the first network information comprises an IP address, port information or NAT (network address translator) type information of the first electronic device.

4. The method as claimed in claim 1, wherein the second network information comprises an IP address, port information or NAT (network address translator) type information of the second electronic device.

5. The method as claimed in claim 1, wherein after the network connection is established, the data transmission between the first electronic device and the second electronic device is implemented by a peer to peer mechanism.

6. The method as claimed in claim 1, wherein the first electronic device informs the second electronic device that a first port of a first firewall is available for data transmission.

7. The method as claimed in claim 5, wherein the second electronic device transmits data to the first electronic device via the first port.

8. The method as claimed in claim 5, wherein when the network connection is established, the control of the first port is transferred to the first electronic device.

9. The method as claimed in claim 1, wherein the second electronic device informs the first electronic device that a second port of a second firewall is available for data transmission.

10. The method as claimed in claim 8, wherein the first electronic device transmits data to the second electronic device via the second port.

11. The method as claimed in claim 8, wherein when the network connection is established, the control of the second port is transferred to the second electronic device.

12. A system in a network environment, comprising:
a third party;
a first electronic device; and
a second electronic device, wherein the first electronic device establishes a network connection to the second electronic device via the third party and after the network connection is established, the first electronic device directly transmits data to the second electronic device.

13. The system as claimed in claim 12, wherein the third party is an email server.

14. The system as claimed in claim 13, wherein the first electronic device transmits a first email comprising a first network information of the first electronic device to the second electronic device via the email server.

15. The system as claimed in claim 14, wherein the first network information comprises a first IP address and a first available port of the first electronic device.

16. The system as claimed in claim 15, wherein the second electronic device transmits data to the first electronic device via the first available port.

17. The system as claimed in claim 13, wherein the second electronic device transmits a second email comprising a second network information of the second electronic device to the first electronic device via the email server.

18. The system as claimed in claim 17, wherein the second network information comprises a second IP address and a second available port of the second electronic device.

19. The system as claimed in claim 18, wherein the first electronic device transmits data to the second electronic device via the second available port.

20. The system as claimed in claim 12, wherein after the network connection is established, commands or requests exchanged between the first electronic device and the second electronic device are transmitted through the third party.

21. The system as claimed in claim 12, wherein after the network connection is established, only data can be directly transmitted between the first electronic device and the second electronic device.
